(19) United States
(12) Patent Application Publication
(10) Pub. No.: US 2017/0182717 A1
(43) Pub. Date: Jun. 29, 2017

(54) MULTIFUNCTION 3D PRINTER

(71) Applicant: Enjet Co. Ltd ., Gyeonggi-do (KR)

(72) Inventors: Do Young Byun, Seoul (KR); Vu Dat Nguyen, Suwon-si (KR)

(21) Appl. No.: 15/371,983

(22) Filed: Dec. 7, 2016

(30) Foreign Application Priority Data
Dec. 29, 2015 (KR) 10-2015-0188760

(51) Int. Cl. B29C 67/00; B33Y 50/02; B22F 3/105; B28B 1/00; B28B 17/00; B33Y 30/00; B33Y 40/00

(52) U.S. Cl. CPC B29C 67/0092; B29C 67/0059; B29C 67/0088; B33Y 30/00; B33Y 50/02; B33Y 40/00; B28B 1/001; B28B 17/0081; B28B 17/009; B22F 3/1055; B22F 2003/1058

(57) ABSTRACT

The invention provides a printer comprising an exchange station by which a printer module of a multifunction 3D printer can be attached and detached. The printer module is electromagnetically or mechanically attached to the exchange station to perform a printing operation. The multifunction 3D printer supports the printer module steadily and stably.

### CROSS-REFERENCE TO RELATED APPLICATION

This application claims priority under 35 U.S.C. §119 to Korean Patent Application No. 10-2015-0188760, filed Dec. 29, 2015, which is herein incorporated by reference in its entirety.

### TECHNICAL FIELD

The invention relates to a multifunction 3D printer.

### BACKGROUND

Descriptions in the background art provide only background information about an embodiment of the invention and do not constitute conventional art.

3D printing is a process of manufacturing a three dimensional solid object based on digital files. In this process, the entire shape of the solid object is formed by stacking layers of material continuously. Digital files are generated by a 3D modeling program such as CAD or a 3D scanner. 3D modeling software segments an image into hundreds or thousands of layers. The 3D printer reads each segmented layer (i.e., two-dimensional image) and performs printing and stacking. After one layer is printed, a bed or a stage on which material is laid moves downward. Almost all process is controlled and performed by a computer provided on the 3D printer.

There are many kinds of 3D printings. For example, material jetting is a method in which material in the form of droplet passes through a nozzle having small diameter and then is cured by ultraviolet rays. Fused deposition modeling (FDM) is a method in which plastic filament or metal wire unwound from a coil passes through a nozzle and then is cured at room temperature without ultraviolet rays. Selective laser sintering is a method of melting plastic, metal, ceramic or glass powder by high energy laser and forming an object.

The applicant applies an EHD (electronic-hydro-dynamics) principle to the 3D printer and the FED principle is performed by applying power to the opposing electrodes to generate static electricity and spraying conductive ink droplet by the generated electric field.

EHD principle can be applied to material jetting method, a FDM method, a laser sintering method, etc. However, even in case of using the EHD method, it is very difficult to perform a precision printing process on the surface of a three dimensional shape, not on a surface.

To solve this problem, in Korean patent No. 1390391, the applicant provides a controller which controls the movement of a nozzle or a stage or the power supply in order to maintain the intensity of electric field between the stage and the nozzle uniformly.

Further, in Korean patent No. 1518402, by applying electrostatic force to FDM, the applicant provides a fused deposition modeling printing apparatus using electrostatic force, comprising: a nozzle part which receives a solid object to be printed and melts the same inside to discharge a liquid object to be printed toward a substrate or a pattern layer formed on the substrate; a storage part which provides liquid in solid state toward the nozzle part; a heating part which heats the nozzle part to melt the liquid in solid state in the inside of the nozzle part, leading to the liquid in liquid state; a voltage supplying part which forms electric field between the substrate and the nozzle part and applies voltage to the nozzle part to discharge the object in liquid state from the nozzle part; and a control part which controls the intensity of the voltage applied to the nozzle part to control the line width of the object in liquid state discharged from the nozzle part.

In Korean patent No. 1552432, by applying the EHD principle to the ink jetting, the applicant provides a three-dimensional patterning apparatus using contact patterning, comprising: a nozzle part; a voltage application part to apply a voltage to a surface of the liquid; and a control part to adjust a level of the voltage applied to the liquid to allow the fluid to be patterned while the liquid being connected to a base plate or the top of the pattern layer on the base plate.

The 3D printer having various functions is manufactured based on printing modules having various specifications. But, a multifunction 3D printer which performs various functions with a single 3D printer has not been disclosed. That is, since conventional 3D printers have used a device having a designated specification based on EHD, EDM, etc., a new 3D printer itself must be purchased whenever another type of printing is needed. Therefore, it costs a lot to replace printer and it is difficult to perform various panorama printings.

The descriptions below are based on ideas to solve the above disadvantages of prior arts.

### BRIEF SUMMARY

### Technical Problem

The invention is intended to provide a multifunction 3D printer by which the printer module can be replaced and can be attached and detached.

Further, the invention is intended to provide a multifunction 3D printer to provide stable support to the replaced printer module and maintain the fixation of the printer module without sway.

### Technical Solution

To achieve the above object, preferably, one embodiment according to the invention provides a multifunction 3D printer comprising: a base having a bed on which an object to be printed is located; and a support which erects on one end of the base and which extends along a width of the base; wherein the support comprises an exchange station configured to attach and detach a printer module of the multifunction 3D printer, and the exchange station comprises a frame.

Preferably, the frame of the exchange station is provided with a magnet which electromagnetically attaches the printer module to the frame and/or an engagement portion which mechanically attaches the printer module to the frame.

Further, the magnet comprises a plurality of magnet arrangements which are arranged along the height of the frame and each of magnet arrangements comprises at least one of magnet element at the same height.

Further, the engagement portion comprises a plurality of engagement arrangements arranged along a height of the frame and each of the engagement arrangements comprises at least one engagement element at the same height.

The printer module which can be attached and detached may be one of the following printer modules: a precision MD printer module, a standard printer module, an electronic-dispenser module, an inkjet module, a FDM module, a laser module, a pick-and-place module and a touch sensor module, but is not limited thereto.

According to one embodiment, the invention provides a multifunction 3D printer, wherein the printer module has an attachment portion and/or a portion to be engaged at locations corresponding to the magnet and/or the engagement portion located on the frame.

### Advantageous Effect

According to one embodiment of the present invention, it is possible to provide a multifunction 3D printer by which various printer modules can be attached and detached and can be replaced.

According to one embodiment of the present invention, it is possible to perform various and wide-range 3D printing operations with a single 3D printer.

Further, the multifunction 3D printer of the invention can provide steady and stable support to the printer module.

Moreover, the invention has various effects such as high durability according to the embodiments and the effects will be described clearly in the detailed description of the embodiments below.

### BRIEF DESCRIPTION OF THE DRAWINGS

FIG. 1 shows a front perspective view of one embodiment of a multifunction 3D printer according to the present invention.

FIG. 2 shows a rear perspective view of another embodiment of a multifunction 3D printer according to the present invention.

FIG. 3 shows a front perspective view of exchange station according to the present invention.

FIGS. 4a to 4h show a front view of one example of a printer module attachable to the multifunction 3D printer according to the present invention.

FIG. 5 shows a perspective view representing that a precision EHD print module is being attached to the exchange station according to the present invention.

FIG. 6 shows a front view representing that a precision EHD print module was attached to the exchange station according to the present invention.

### DETAILED DESCRIPTION

Hereinafter, an embodiment of the present disclosure will be explained in detail with reference to the exemplary drawings attached. In adding a reference numeral to each element in the drawings, it should be noted that like elements use like reference numerals if possible even if the elements are illustrated in other drawings. Further, in explaining an embodiment of the present disclosure, any specific explanation on a well-known configuration or function regarded as possibly obscuring the main point of the present disclosure will be omitted.

In explaining the elements of an embodiment of the present disclosure, terms such as a first, a second, A, B and the like, may be used. Such terms are intended to distinguish those elements from other elements, not to limit the essence, the order and the like of the corresponding elements. In the present specification, when it is disclosed that an element ‘includes’, ‘comprises’ or ‘is provided with’ any element or elements, it does not exclude the possibility of adding another element unless mentioned otherwise, but may further include other elements.

When it is described that an element is connected to, engaged with, or coupled to other element, it is noted that the element can be directly connected to, engaged with or coupled to the other element and also another element can be connected, engaged, or coupled between the respective elements.

Further, the size or shape of the element shown in the figure can be exaggerated for clearness and convenience. The terms defined considering the constitutions and effects of the invention are just intended to explain the embodiments and not intended to limit the scope of the invention.

Hereinafter, an entire structure, a module and a mounting method of a multifunction 3D printer according to one embodiment of the invention will be explained sequentially.

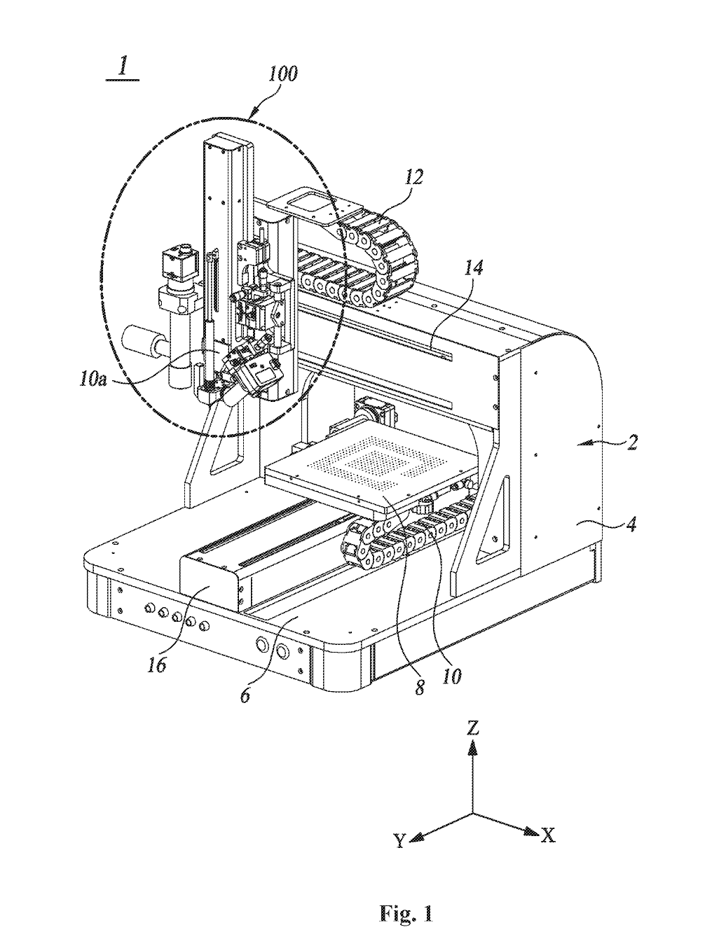

Referring to FIG. 1, the entire structure of a multifunction 3D printer according to one embodiment of the present invention will be described. Hereinafter, for easy understanding, an orientation along the width is defined as X axis is, an orientation along the length is defined as Y axis, and an orientation along the height is defined as Z axis with regard to the multifunction 3D printer 1.

The multifunction 3D printer 1 comprises a platform 2 having an exchange station 100. The platform 2 comprises a base 6 having the shape of a square and a support 4 having the shape of “ [symbol] ” which erects on one end of the base 6 and spans across the base 6.

The exchange station 100 is arranged at the front surface of the support 4 and near the center as shown in the figure. In one example, a high-precision EHD printer module 10a is attachably installed on the exchange station 100. The location of the exchange station 100 is not limited to a specific position, but is movable depending on the printing operation.

A square shaped Y-axis guide 16 extends along the length of the base 6 on the center of the width direction of the base 6. A caterpillar 10 is slidably arranged on both sides of the Y-axis guide 16 along the Y axis and the caterpillar 10 supports a bed 8 on which 3D printing material is stacked. As well known to those skilled in the art, the bed 8 can be a blank-type bed on which printing material is stacked from the beginning or a platform-type bed which supports a shaped object whose surface is needed to be printed. In case of the platform-type bed, 3D printing begins at the outer surface of the object.

A bridge portion of the support 4 is provided with a guide groove 14 along the X-axis as a X-axis guide. A guide pin (not shown) of the exchange station 100 or of the high-precision EHD printer module 10a mounted on the exchange station 100 is inserted into the guide groove 14. A caterpillar 12 guides the movement of the exchange station 100 and the high-precision EHD printer module 10a along the X axis, similarly to the caterpillar 10.

By the actuation of a motor connected to a controller which is not shown, the bed 8 moves along the length of the base 6, and the exchange station 100 and the high-precision EHD printer module 10a move along the width of the base in order to carry out the printing operation.

The high-precision EHD printer module 10a moves along the height by the Z-axis driving device which is not shown. Once the printing on one layer is finished, the high-precision EHD printer module 10a moves upward from the bed 8 by a predetermined distance for the printing of the next layer. Alternatively, the module is fixed and the bed 8 may move downward by a predetermined distance.

The form, shape and size of the multifunction 3D printer 1 of the invention as described above are just one example, and they can be modified in the level of those skilled in the art.

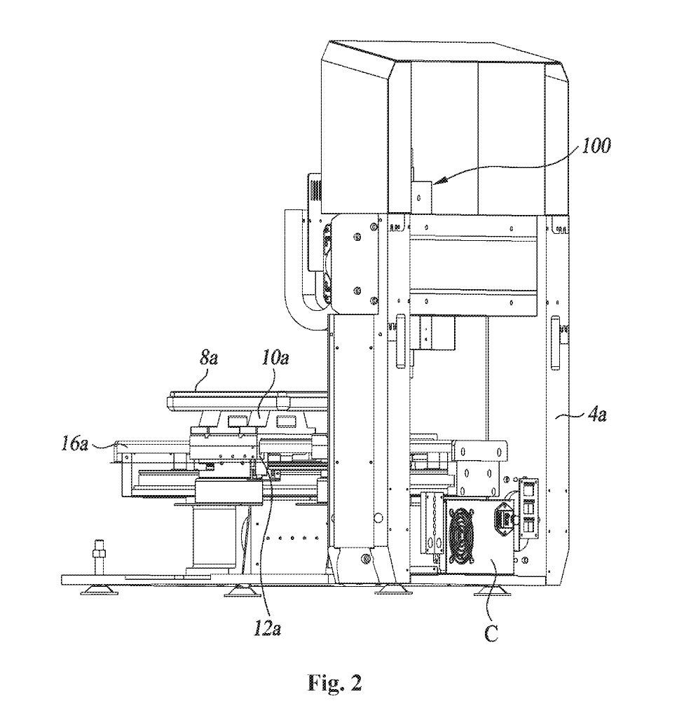

For example, FIG. 2 shows a rear perspective view of another example of the multifunction 3D printer 1 of the invention.

The difference from FIG. 1 is that the support 4a has the shape of “H” and the exchange station 100 is arranged on the bridge portion.

Further, the bed 8a is mounted on the Y-axis guide 16a having a long groove on both sides, and a hooking portion 12a integrally formed on a bracket 10a which supports the bed 8a is inserted into the groove such that the bed moves back and forth along the length by the linear movement of the bracket 10a. An element referenced by “C” is an electronic device which controls and carries out the printing operation such as a computer.

As obvious to those skilled in the art, the operation of the electronic device C to control and carry out the printing comprises the following function: reset of the 3D printer, recognition of the printer module, zeroing, reading of electronic file by 3D modeling program, actuation of the printer module, lamination printing of segmentalized fine layers, transmission and reading of a shape of the object to be formed, and feedback control.

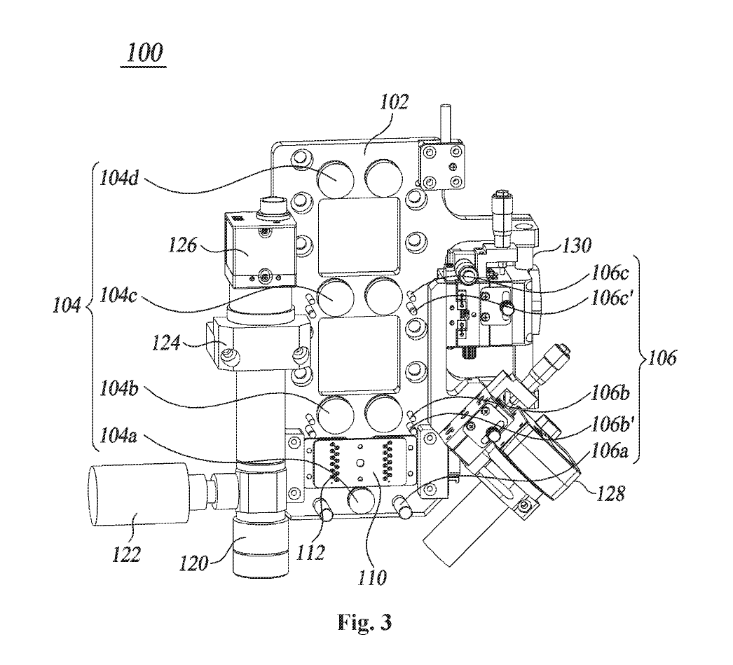

Next, referring to FIG. 3, the exchange station 100 of the invention will be described.

The exchange station 100 of the invention comprises a flat-plate frame 102 of the rectangle shape. The frame 102 is designed such that it provides a large space enough to accommodate any exchangeable printing module.

The exchange station 100 has magnets 104 and engagement portions 106 on the frame 102 for the attachment and detachment of various printing modules. The magnet 104 is configured to electromagnetically attach the printer module to the frame 102 of the exchange station 100, and the engagement portion 106 is configured to mechanically attach the printer module to the frame 102 of the exchange station 100. Therefore, according to the disclosure of the present invention, strong support and stability without sway can be provided by the combination of the electromagnetic adhesion force and the mechanical engaging force.

The magnet 104 consists of a first magnet arrangement 104a on the lowest along the height of the frame 102, a second magnet arrangement 104b and a third magnet arrangement 104c arranged in order upwardly with a predetermined distance above the first magnet arrangement 104a, and a fourth magnet arrangement 104d on the highest. Preferably, magnet arrangements 104a-104d are spaced apart from each other by the same distance along the height of the frame 102.

Each magnet arrangement 104a-104d comprises at least one magnet on the same line. The shape of the magnet is a protruding circle or a short cylinder, but not limited to this shape.

The magnet can be made of any material having magnetic force and it is preferably made of ferromagnetism material in the form of an alloy such as magnetized iron, nickel, metal containing cobalt or metal oxide such as iron oxide, chromium oxide, ferrite, etc.

The first magnet arrangement 104a is configured such that one magnet element is arranged on the center of the width of the frame 102, but a plurality of magnet elements can be arranged on the same height. Similarly, the second to fourth magnet arrangements 104b-104d are arranged such that each magnet element is located on the left and the right from the center of the width of the frame 102, but more than three magnet elements or one magnet element can be arranged.

In the embodiment, the magnets 104 are configured such that a plurality of magnet arrangements are arranged differently along the height and therefore, any printer module can be provided with strong adhesion and steady support regardless of the shape, i.e., the height and the occupying area, of the printer module attached to the exchange station 100. Once the printer module is attached to the exchange station 100, it is important that printing operation is carried. out at fixed position without sway.

Referring to FIG. 3, the engagement portion 106 comprises a first engagement arrangement 106a on the lowest along the height of the frame 102, a second engagement arrangement 106b and a third engagement arrangement 106c arranged in order upwardly by predetermined distance above the first engagement arrangement 106a.

Preferably, engagement arrangements 106a-106c are spaced apart from each other by the same distance along the height of the frame 102.

Each engagement arrangement 106a-106c comprises at least one engagement element on the same height. In the figure shown, the shape of the engagement element is a protruded pin, but it is not limited to this shape.

The first to third engagement arrangements 106a-106c are arranged such that each engagement element is located on the left and the right from the center of the width of the frame 102, but more than three protruded portions or one protruded portion can be arranged. Further, similarly to the magnet 104, a fourth engagement arrangement can be arranged on the highest location of the frame 102. A second sub-engagement 106b′ and a third sub-engagement 106c′ are additionally provided near and under the second engagement arrangement 106b and the third engagement arrangement 106c, respectively. The sub-engagement is intended to increase the engaging force of the adjacent engagement arrangement. The shape of the sub-engagement can be a pin as shown, but not limited to this shape. For example, the shape can be the same as the magnet 104, thereby enhancing the engaging force.

Preferably, the shape and dimension of the first engagement arrangement 106a are configured such that they can be bigger than the other engagement arrangements. This is because it is advantageous that in case of the printer module mounted on the exchange station 100, the bottom where a nozzle is arranged is securely attached.

In the embodiment, the engagement portion 106 is configured such that a plurality of engagement arrangements are arranged differently along the height and therefore, any printer module can be provided with strong adhesion and steady support regardless of the shape, i.e., the height and the occupying area, of the printer module attached to the exchange station 100.

According to the magnet 104 and the engagement portion 106 for the attachment and detachment as described above, the magnet 104 provides strong electromagnetic force, the engagement portion 106 provides strong mechanical engaging force and the magnet 104 and the engagement portion 106 are uniformly distributed on the front surface, so that strong support can be provided to the printer module which is a member to be engaged and printing operation can be carried out at fixed position without sway once the printer module is attached to the exchange station 100.

The above description explains one example of the magnet 104 and the engagement portion 106. As long as the printer module is provided with strong support, the arrangement, shape, location and size can be adjusted properly. Further, only one line arrangement can be provided to support the bottom securely, or any one of the magnet 104 and the engagement portion 106 can be also selected.

Instead of the magnet 104 and/or the engagement portion 106 or in addition to the magnet 104 and/or the engagement portion, the following engaging structure can be used.
A. Screw-bolt engagement instead of a pin or in addition to a pin
B. Engagement by adhesion of the printer module by magnetic force, by means of the magnet comprising solenoid and the coil electric conduction with a switch

Referring to FIG. 3, an interface 110 extends along the width of the frame 102 on the bottom of the frame 102. Connectors 112, arranged in four columns, are formed on the interface 110 along the height of the interface 110. The connectors 112 are connected to an electronic device C. When the printer module is mounted, a connection terminal of the printer module is connected to the connectors 112 such that the electronic device C detects the printer module and controls the 3D printing set based on the detected module.

On the left of the frame 102, a first lens portion 120, a holder 124 and a CCD camera 126 are attached in order from the bottom, thereby forming a first arrangement device. A heat sink referenced by a number 122 has an LED therein.

Also, on the right of the frame 102, a second lens 128 and a location and focus controller 130 are attached in order from the bottom, thereby forming a second arrangement device.

The first and second arrangement devices are configured to perform a calibration, i.e., zeroing function, based on the printer module. A device for zeroing and the method thereof are described in detail in another patent application of the applicant and the detailed descriptions thereof are omitted herein.

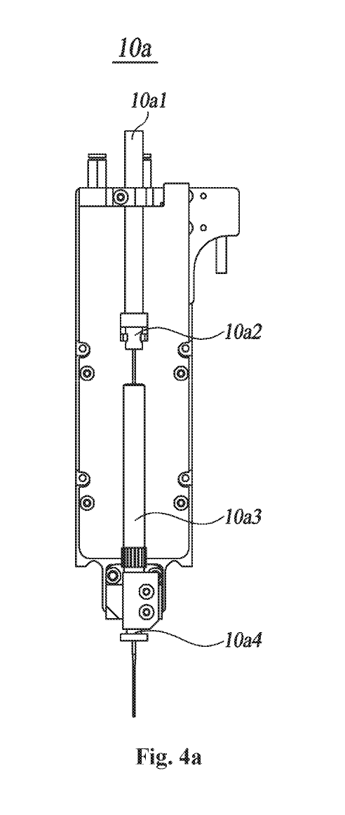

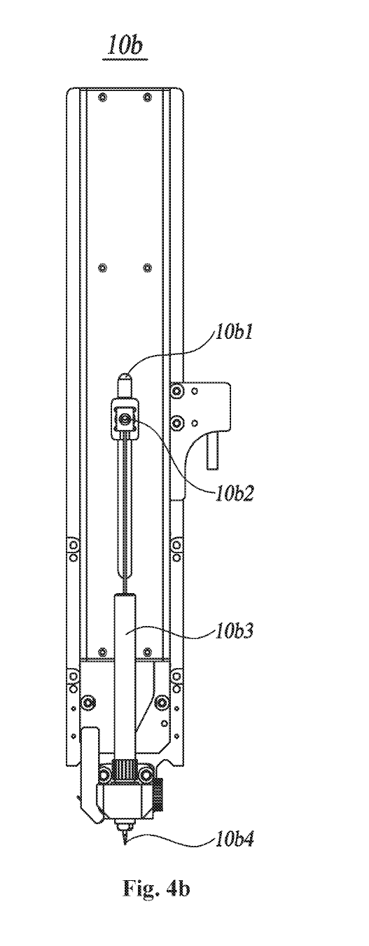

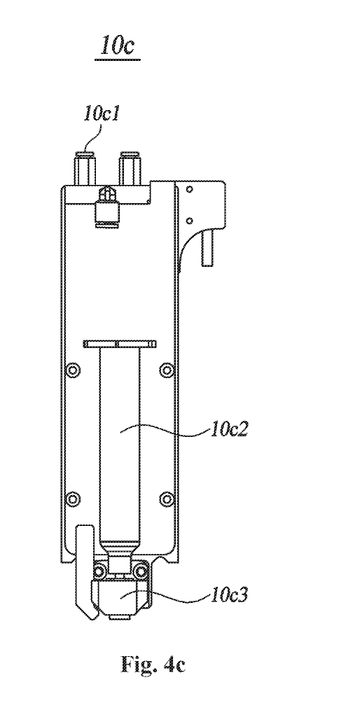

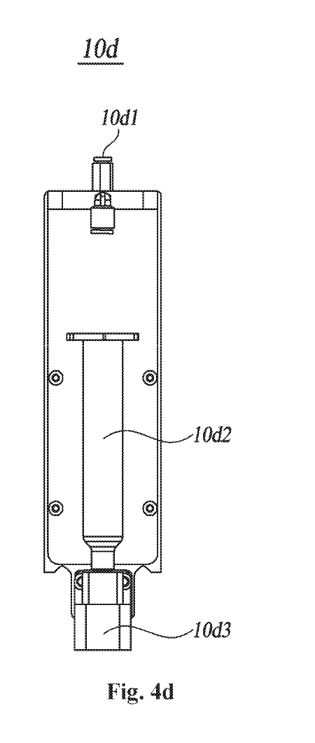

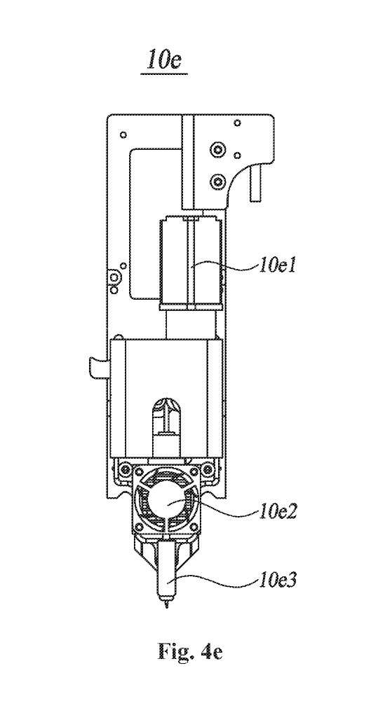

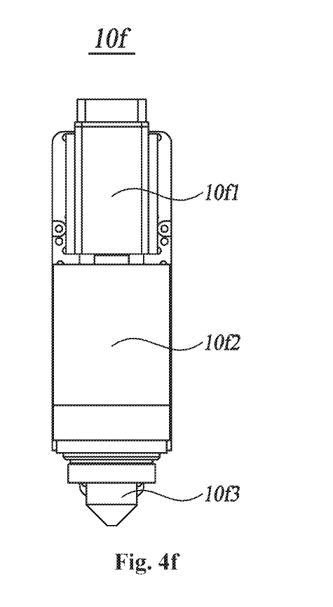

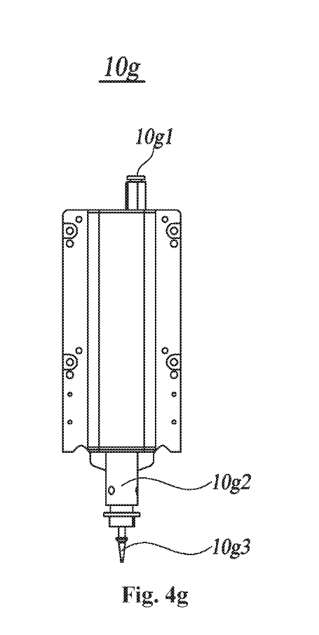

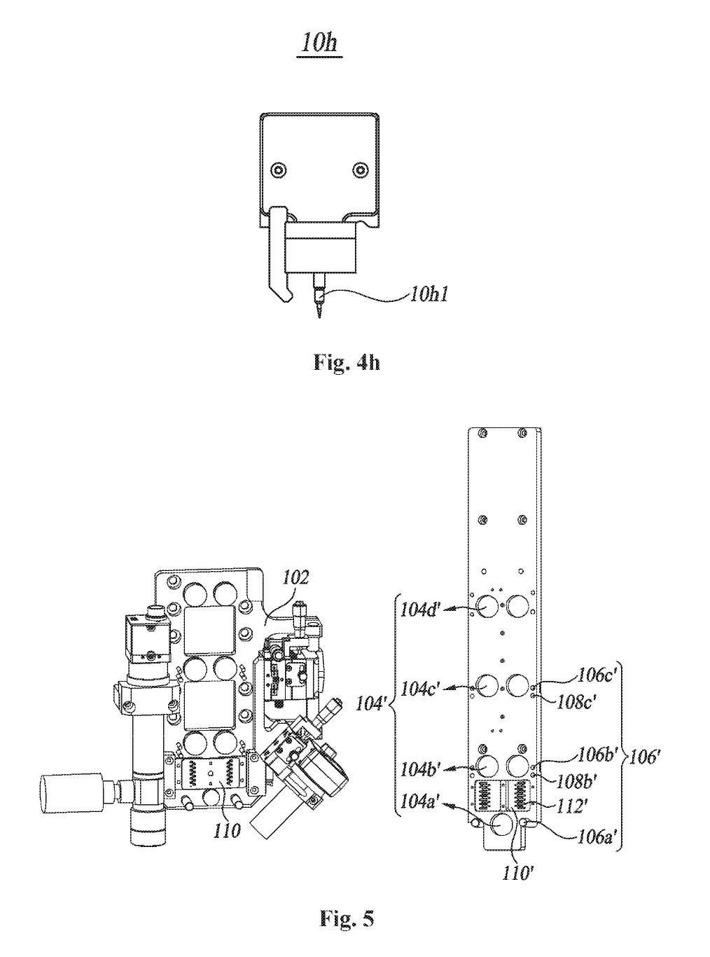

Each drawing in FIG. 4 shows a front view of the printer module mounted on the exchange station 100 of the multifunction 3D printer 1 of the invention. Hereinafter, each module will be described.

FIG. 4a shows a high-precision EHD printer module 10a. As a high-precision patterning module, a pneumatic type module is used, and the size of a nozzle is below 10 μm and a line width of printing is controlled to be below 1 μm. When an air pressure is delivered through two inlets 10a1, one air-pressure flow path is selected and by the movement of a syringe 10a3 attached to a holder 10a2, a pipe 10a4 made of SUS material transfers solution to the nozzle.

In the EHD module, an electric field controller (not shown) is provided to apply a voltage to solution. The pressure and displacement of the syringe may be predefined based on the flow quantity and the flow rate of liquid discharged from the nozzle.

FIG. 4b shows a standard EHD module 10b. As a high-precision patterning module, a pneumatic type module is used, and the size of a nozzle is below 100 μm and a line width of printing is controlled to be below 2-3 μm. When an air pressure is delivered through an inlet 10b1, the movement of a syringe 10b3 attached to a holder 10b2 transfers solution directly to the nozzle 104.

FIG. 4c shows an electronic dispenser (E-dispenser) module 10e. The electronic dispenser module is mainly used to perform 3D printing on the surface of the shaped object. Solution can be a metal, semi-conductor, polymer, ceramic and composition. The electronic dispenser has advantages to prevent waste of material and to be able to increase energy efficiency.

When air pressure is delivered through two inlets 10c1, one air-pressure flow path is selected and solution stored in a barrel 10c2 is discharged through a nozzle 10c3 and then is sintered and dried. The nozzle 10c3 can be in the form of a capillary tube and a plurality of nozzles can be used to mix various materials and print them.

FIG. 4d shows an inkjet module 10d. The inkjet module 10d is similar to a conventional inkjet printer using a cartridge, but is different from a conventional inkjet printer in that a photopolymer layer, e.g., a liquid to be cured, is sprayed on a mold tray, instead of ink droplets being sprayed on a paper. When an air pressure is delivered through an inlet 10d1, solution stored in a barrel 10d2 is discharged through a nozzle 10d3 and then is sintered and dried. A valve is arranged between the barrel 10d2 and the nozzle 10d3 to initiate and stop the spray of solution by the on/off operation of the valve.

FIG. 4e shows a FDM module 10e. The actuation of an extruding motor 10e1 discharges material such as plastic filament or metal wire through a heating nozzle 10e3 as solution. A cooling fan 10e2 is configured to cool the heating nozzle 10e3.

FIG. 4f shows a laser module 101 Laser from a laser source 10f1 is focused by a lens unit 10f2 comprising a focusing lens and passes through a nozzle 10f3 to form a spot.

FIG. 4g shows a pick-and-place module 10g. The pick-and-place module 10g uses a spray principle of the 3D printing inversely to pick a minute electronic element and displace it to a predetermined location and makes it possible to monitor the pick-and-place of an element precisely by means of a monitor. When a vacuum is generated by an inlet 10g1, negative pressure allows a minute element to be adsorbed through a nozzle 10g3. When a vacuum is released at a predetermined location after the displacement of the module, the element attached to the nozzle 10g3 falls off. An element referenced by a number 10g2 is a rotation body configured to place an element in a proper position at a predetermined location.

FIG. 4h shows a touch sensor module 10h. The touch sensor module 10h does not participate in a 3D printing operation and a sensor tip portion 10h1 moves up and down to measure the height step of a board such as a bed and scan a geometrical structure. The measurement of shape including the step of bed is needed as a preliminary operation for a precise 3D printing operation. The moving distance of the sensor tip 10h1 is within 2 mm.

It is noted that each printer module as described above is an example of a model which can be attached to the exchange station 100 of the invention and any printer module which is to be developed currently or in the future can be attached to the exchange station 100 of the invention.

Now, referring to FIG. 5, the structure by which the printer module is attached to or detached from the exchange station 100 will be described. For convenience, it will be explained for example by the high-precision EHD printer module 10a and other printer modules described above can be adapted properly and applied to this.

As shown in the figure, the rear surface of the high-precision EHD printer module 10a is provided with an adhesive portion 104′ and a portion to be engaged 106′ at the locations corresponding to the magnet 104 and the engagement portion 106 arranged on the frame 102. For easy understanding, each element corresponding to element of the frame 102 uses the same reference numerals with the addition of a prime (′).

The adhesive portion 104′ comprises a ferromagnetic body and metal material to be engaged by magnetic force and is formed as a circular concave socket.

Alternatively, without the adhesive portion 104′, the entire rear surface of the high-precision EHD printer module 10a can be made of a flat metal plate.

The portion 106′ to be engaged is in the shape of a concave groove to receive the engagement portion 106. The portion 106′ to be engaged and the engagement portion 106 can be engaged by an insertion of a pin, a rotation of a screw, etc.

Further, differently from the above example, the engagement portion 106 can be an open slot and the portion to be engaged 106′ can be a protruding screw. Then, the high-precision EHD printer module 10a is attached to the exchange station 100 temporarily and then the printer module and the exchange station are firmly engaged to each other by fastening the protruding screw.

Reference number 110′ indicates a connection portion which corresponds to the interface 110 of the frame 102 and the connection portion 110′ is provided with a connection terminal 112′ to correspond to the connector 112 of the interface 110.

The high-precision EHD printer module 10a is a long member which extends over the height of the frame 102 and thus, has one-to-one constitutions which correspond to all the magnets 104 and the engagement portions 106 of the frame 102. This is true for the standard EHD printer module 10b.

However, in case of a small module which does not extend over the height of the frame 102, i.e., the pick-and-place module or the touch sensor module, all the corresponding constitutions do not need to exist. In case of such a small module, the adhesive portion 104′ and the portion to be engaged 106′ need to be adjusted according to the size and dimension, e.g., so as to have one column arrangement or two column arrangement.

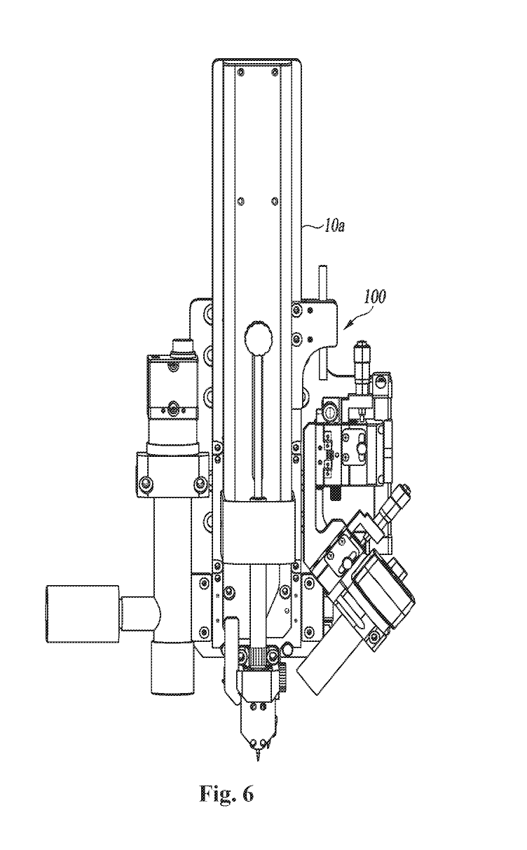

FIG. 6 shows a front view of the high-precision EHD printer module 10a of FIG. 5 mounted on the exchange station 100.

The printer module is released by detaching the printer module with hands or tools or by disconnecting the electric connection to the solenoid, thereby the detachment of the printer module can be carried out easily.

In the above, preferred embodiments of the invention were described referring to the attached drawings. The disclosure can be varied with regard to the shape, location and arrangement based on the embodiments within the same scope of technical spirit. Therefore, the scope of the invention is not limited to specific embodiments described above and is within the claims attached below and the equivalents thereof.

What is claimed is:

1. A multifunction 3D printer comprising:
a base having a bed on which an object to be printed is located; and
a support which erects on one end of the base and which extends along a width of the base;
wherein the support comprises an exchange station configured to attach and detach a printer module of the multifunction 3D printer, and the exchange station comprises a frame.

2. The multifunction 3D printer according to claim 1, wherein the frame of the exchange station is provided with a magnet to electromagnetically attach the printer module to the frame.

3. The multifunction 3D printer according to claim 1, wherein the frame of the exchange station is provided with an engagement portion to mechanically attach the printer module to the frame.

4. The multifunction 3D printer according to claim 2, wherein the frame of the exchange station is provided with an engagement portion to mechanically attach the printer module to the frame.

5. The multifunction 3D printer according to claim 3, wherein the magnet comprises a plurality of magnet arrangements which are arranged along the height of the frame and each of magnet arrangements comprises at least one of magnet element at the same height.

6. The multifunction 3D printer according to claim 4, wherein the magnet comprises a plurality of magnet arrangements which are arranged along the height of the frame and each of magnet arrangements comprises at least one of magnet element at the same height.

7. The multifunction 3D printer according to claim 5, wherein the magnet is made of ferromagnetism material.

8. The multifunction 3D printer according to claim 6, wherein the magnet is made of ferromagnetism material.

9. The multifunction 3D printer according to claim 5, wherein the magnet comprises a solenoid and the printer module is attached by magnetic force when electric current is applied to the solenoid.

10. The multifunction 3D printer according to claim 6, wherein the magnet comprises a solenoid and the printer module is attached by magnetic force when electric current is applied to the solenoid.

11. The multifunction 3D printer according to claim 3, wherein the engagement portion comprises a plurality of engagement arrangements arranged along a height of the frame and each of the engagement arrangements comprises at least one engagement element at the same height.

12. The multifunction 3D printer according to claim 4, wherein the engagement portion comprises a plurality of engagement arrangements arranged along a height of the frame and each of the engagement arrangements comprises at least one engagement element at the same height.

13. The multifunction 3D printer according to claim 11, wherein the engagement element is in the shape of a protruded pin.

14. The multifunction 3D printer according to claim 12, wherein the engagement element is in the shape of a protruded pin.

15. The multifunction 3D printer according to claim 3, wherein the printer module is one of the following printer modules:
(a) a precision patterning module comprising two inlets, a holder, a syringe attached to the holder and a pipe which transfers solution material to a nozzle by the movement of the syringe;
(b) a precision patterning module comprising an inlet, a holder, a syringe attached to the holder, a nozzle which sprays solution material by the movement of the syringe;
(c) an electronic-dispenser module comprising two inlets, a barrel hick transfers solution to a nozzle by air pressure through the inlets, and a nozzle;
(d) an inkjet module comprising an ink cartridge which supplies ink, an inlet, a barrel which supplies solution to a nozzle by air pressure through the inlet, and a valve between the nozzle and the barrel;
(e) a FDM module comprising an extruder motor, a heating nozzle which sprays material such as plastic filament or metal wire in a solution by the actuation of the extruder motor, and a cooling fan which cools the heating nozzle;
(f) a laser module comprising a laser source, a lens unit comprising a focusing lens to collect laser from the laser source, and a nozzle which forms a laser spot;
(g) a pick-and-place module comprising an introduction portion into which a vacuum pressure is introduced, a nozzle which applies attaching force to an outer object by means of vacuum pressure, and a rotating body to rotate the outer object; and
(h) a touch sensor module comprising a sensor tip to measure a height step of a substrate such as a bed and scan a geometry structure.

16. The multifunction 3D printer according to claim 4, wherein the printer module is one of the following printer modules:
(a) a precision patterning module comprising two inlets, a holder, a syringe attached to the holder and a pipe which transfers solution material to a nozzle by the movement of the syringe;
(h) a precision patterning module comprising an inlet, a holder, a syringe attached to the holder, a nozzle which sprays solution material by the movement of the syringe;
(c) an electronic-dispenser module comprising two inlets, a barrel hick transfers solution to a nozzle by air pressure through the inlets, and a nozzle;
(d) an inkjet module comprising an ink cartridge which supplies ink, an inlet, a barrel which supplies solution to a nozzle by air pressure through the inlet, and a valve between the nozzle and the barrel;
(e) a FDM module comprising an extruder motor, a heating nozzle which sprays material such as plastic filament or metal wire in a solution by the actuation of the extruder motor, and a cooling fan which cools the heating nozzle;
(f) a laser module comprising a laser source, a lens unit comprising a focusing lens to collect laser from the laser source, and a nozzle which forms a laser spot;
(g) a pick-and-place module comprising an introduction portion into which a vacuum pressure is introduced, a nozzle which applies attaching force to an outer object by means of vacuum pressure, and a rotating body to rotate the outer object; and
(h) a touch sensor module comprising a sensor tip to measure a height step of a substrate such as a bed and scan a geometry structure.

15. The multifunction 3D printer according to claim 15, wherein the printer module has an attachment portion and/or a portion to be engaged at locations corresponding to the magnet and/or the engagement portion located on the frame so that the printer module is attached to and detached from the exchange station.

18. The multifunction 3D printer according to claim 16, wherein the printer module has an attachment portion and/or a portion to be engaged at locations corresponding to the magnet and/or the engagement portion located on the frame so that the printer module is attached to and detached from the exchange station.
